(19) United States
(12) Patent Application Publication
(10) Pub. No.: US 2015/0035358 A1
(43) Pub. Date: Feb. 5, 2015

(54) ELECTRICAL POWER MANAGEMENT SYSTEM AND METHOD

(71) Applicant: RAGINGWIRE DATA CENTERS, INC., RENO, NV (US)

(72) Inventors: Charles O. Linkhart, Shingle Springs, CA (US); George Macricostas, Incline Village, NV (US)

(73) Assignee: RAGINGWIRE DATA CENTERS, INC., RENO, NV (US)

(21) Appl. No.: 14/220,810

(22) Filed: Mar. 20, 2014

Related U.S. Application Data
(60) Provisional application No. 61/862,446, filed on Aug. 5, 2013.

(51) Int. Cl. H02J 9/06

(52) U.S. Cl. CPC H02J 9/061
USPC 307/23; 307/64

(57) ABSTRACT

An electrical power system and a method of managing electrical power. Some embodiments provide improved fault isolation and service continuity circuitry. In some embodiments, a first source breaker is connected in series with a first load breaker. The load breaker can include a shunt trip, and the source breaker can include an associated lockout relay. The lockout relay can be in controlling communication with the shunt trip. Each source breaker can be in power-receiving connection with a power source. A controller can close and open the breakers according to which power source can provide power.

### CROSS-REFERENCE TO RELATED APPLICATION

This patent application claims priority from the applicant's Provisional Patent Application Ser. No. 61/862,446, filed Aug. 5, 2013, the entire contents of which are incorporated herein by reference.

### BRIEF BACKGROUND

In many operating environments, it is critical that electronic equipment or other electrically-powered appliances not suffer from interruptions of electrical power. For example, power failure for medical appliances in hospitals can be devastating. Likewise, computer servers in a data center may be performing critical functions related to any of numerous vital (and other) services such as air traffic control, telephone switching, cell towers, and police emergency services, to name but a few; and so providing reliable continuous power for such data centers has long been a major objective. Some appliances can tolerate brief power interruptions but many others cannot, and various methods have been employed to seek to provide uninterrupted electrical power to these critical devices.

Electrical power failures can result from many causes. Some occur from accidents or equipment malfunctions in commercially-provided power. Others may be locally-caused, for example from some kind of malfunction or short circuit within a hospital or a server farm or even in a single rack of computer equipment.

One way of maintaining power to critical appliances, at least on a short-term basis, is to provide a battery backup. Local generators, for example powered by natural gas, are another option. When transferring an electrical load from one power source to another, however, service continuity without any interruption may be critical or, in any event, desired for a number of reasons. Service continuity can be particularly important in the context of loads such as “always on” facilities. To maintain service continuity to such equipment, the power supply chain can be provided with various types of redundancy.

Although service continuity may be important and even paramount, fault isolation has long been equally important in many applications. For example, it can be desirable and even essential to isolate (i) critical loads from any effects of a fault found somewhere in the power delivery supply chain and (i) to isolate a power supply system or parts of a power supply system from effects of a fault occurring in equipment downstream of the power supply.

Various kinds of power supplies and methods of managing electrical power have been devised to seek to meet the requirements of service continuity and fault isolation. They have done so with varying degrees of success, usually at significant cost. To the applicant's knowledge, these prior art systems have not provided sufficient service continuity to critical electrical and electronic appliances while also enabling faults to be safely isolated for maintenance and repair.

### BRIEF SUMMARY OF SOME ASPECTS OF THE SPECIFICATION

The applicant believes that he has, among other things, discovered at least some of the issues, and their severity, recited in the Background above.

One aspect of the present specification provides an electrical power system with service continuity and isolation of faults from active power circuits. In some embodiments, the system includes two source breakers, and two load breakers, each load breaker in series connection with one of the source breakers. Each load breaker has a shunt trip and the source breaker has a lockout relay in controlling communication with the shunt trip. The first source breaker is in a power-receiving connection with a first power source and the second source breaker is in power-receiving connection with a second power source. A controller is in communication with the source breakers to close the first source breaker and open the second source breaker if power is available from the first power source and if the first source breaker is not in a tripped state. If power ceases to be available from the first power source or if the first source breaker trips, the second source breaker is closed and the first source breaker is opened if power is available from the second power source and if the second source breaker is not in a tripped state.

In some examples both source breakers are in power-providing communication with one load through the load breakers. In these examples, the load can be powered from either power source.

In some examples the controller comprises a single unit that communicates with both source breakers, and in other examples the controller comprises two control units, one in controlling communication with each of the source breakers. Using two control units is one way to provide redundancy such that if one controller fails, power can still be provided to the load.

Certain systems include a synchronizer that detects when the two power sources are in sync with each other and communicates this information to the controller. For example, if the power sources provide alternating current (AC), the synchronizer can report when the two power sources are in phase with each other such that one power source can be connected to the load at the same instant as the other is disconnected, providing continuous power to the load through the switching process without stressing either power source.

Some embodiments include more source breakers in power-receiving connection with additional power sources, more load breakers receiving power from the source breakers, and more loads. These embodiments can implement Zipper Logic^{SM} functionality, by which several loads can be switched sequentially among power supplies if one supply fails. For example, there may be a third source breaker similar to the first and in power-receiving connection with the second power source, and a fourth source breaker similar to the first and in power-receiving connection with a third power source. These two source breakers are in power-providing connection through load breakers with a second load. Similarly, a fifth similar to the first and in power-receiving connection with the third power source, and a sixth similar to the first and in power-receiving connection with a fourth power source, may be provided. The fifth and sixth source breakers are in power-providing connection with a third load through additional load breakers.

If power ceases to be available from any of the four power sources, or if any source breaker trips, the controller is in communication with the source breakers to cause the source breakers to establish electrical power connections between the remaining power sources and loads in sequence such that no load is connected to more than one source. Some examples include additional pairs of source breakers and power sources, and so long as the number of power sources exceeds the number of loads, the loads can be sequentially switched among the power sources.

Some embodiments also include an auxiliary breaker in power-carrying connection with an auxiliary power source, for example a generator, a load-bank breaker in power-carrying connection with a load bank bus, a tie breaker in power-receiving connection with the auxiliary and load-bank breakers and in power-providing connection with the source breaker, and a utility breaker in series between the source breaker and the power source. In this embodiment the controller is in communication with the breakers to close the utility breaker if power is available from the power source to which the source breaker is connected, and if not, to close the auxiliary and tie breakers, and if power is not available from the auxiliary power source but is available from the load bank bus, to close the tie and load-bank breakers.

It may happen that two loads lose power from their respective sources but a third auxiliary power source is not being used. In this case, the controller can open the tie breaker and close the auxiliary and load-bank breakers associated with the third auxiliary power source, and close the tie and load-bank breakers for one of the two affected loads. This can enable power to be provided from the third auxiliary power source to the load through the load bank bus even if the third auxiliary power source and the loads are in different subsystems.

An example of a method of managing electrical power in a power distribution system having more power sources than loads includes applying power from a first power source through a first source protector to a load through a first load protector, upon failure of the first power source to provide power or upon trip of the first source protector, applying power from a second power source through a second source protector to the load through a second load protector, and upon trip of the first source protector, locking the first source protector and the first load protector in an open-circuit state. In some examples the load is shut down if the second source protector is tripped.

In another example, if the second power source is already providing power to another load, the loads are redistributed by sequentially switching each load from one power source to another such that all loads are being provided with power and no power source is providing power to more than one load.

In another example, each power source comprises primary and auxiliary power supplies, and failure of a power source to provide power means failure to provide power from its primary and auxiliary power supplies.

In some systems, upon failure of a second load to receive power from its associated power sources, an unused auxiliary power supply is identified and power from the identified auxiliary power supply is applied to the second load. For example, this may be done by connecting the identified auxiliary power supply to a load bank bus.

There are other novel features and aspects of the present specification. They will become apparent as the specification proceeds. In this regard, it is understood that the scope of the invention is to be determined by the claims as issued and not by whether they address any issues set forth in the Background or provide a feature recited in this Brief Summary of Some Aspects of the Specification.

### BRIEF DESCRIPTION OF THE DRAWINGS

The applicant's preferred and other embodiments are disclosed in the accompanying Figures in which:

FIG. 1A is a partial schematic diagram of an electrical power system including a breaker-transfer pair according to an embodiment;

FIG. 1B is a partial schematic diagram of a portion of FIG. 1A, showing a breaker transfer pair;

FIG. 1C is a partial schematic diagram of a portion of FIG. 1A, showing a breaker transfer pair with a sync unit;

FIG. 1D is a partial schematic diagram of a portion of FIG. 1A, showing a breaker transfer pair that prevents power from being conducted to the backside of a source isolation breaker;

FIG. 1E is a partial schematic diagram of a portion of FIG. 1A, showing redundant control;

FIG. 2A is a partial schematic of a circuit having multiple breaker transfer pairs similar to the breaker transfer pair of FIG. 1A and implementing Zipper Logic^{SM} functionality;

FIG. 2B shows the circuit of FIG. 2A in which loads 1 to 5 are being serviced by power sources 1 to 5, respectively;

FIG. 2C shows the circuit of FIG. 2A in which the third power source has become unavailable and loads 3 to 5 have been switched to power sources 4 to 6, respectively, according to Zipper Logic^{SM} functionality;

FIG. 3A is a partial schematic of another circuit having multiple breaker transfer pairs similar to the breaker transfer pair of FIG. 1A and implementing Zipper Logic^{SM} functionality with two loads per power source;

FIG. 3B shows the circuit of FIG. 3A in which the loads are being serviced by power sources 1 and 6 half loaded and 2 to 5 fully loaded;

FIG. 3C shows the circuit of FIG. 3A in which the third power source has become unavailable and loads 3 to 5 and 8 to 10 have been switched to power sources 4 to 6, respectively, according to Zipper Logic^{SM};

FIG. 4 is a partial schematic of an electrical power system including a breaker-transfer pair according to an embodiment and including provision for an auxiliary power source and a load bank bus;

FIG. 5A is a partial schematic of a circuit having two subsystems each with multiple breaker transfer pairs similar to the breaker transfer pair of FIG. 4 and implementing Zipper Logic^{SM} functionality within each subsystem and load bank power transfer between the subsystems;

FIG. 5B shows the circuit of FIG. 5A in which the loads are being serviced by all power sources except 5 and 6;

FIG. 5C shows the circuit of FIG. 5A in which two power sources have become unavailable and some of the loads have been switched to other power sources according to Zipper Logic^{SM} functionality;

FIG. 5D shows the circuit of FIG. 5A in which two power sources in the same subsystem have become unavailable, one load has been switched according to Zipper Logic^{SM} functionality, and one load is receiving power through the load bank bus;

FIGS. 6A and 6B are a flowchart illustrating a method managing electrical power in a power distribution system having more power sources than loads; and

FIG. 6C is a flowchart continuing the flowchart of FIGS. 6A and 6B depicting a method of managing electrical power in a power distribution system having more than one subsystem and auxiliary power sources.

### DETAILED DESCRIPTION

Illustrative examples and details are used in the drawings and in this description, but other configurations may exist and may suggest themselves. Parameters such as voltage, temperature, dimensions, and component values are approximate. Terms of orientation such as up, down, top, and bottom are used only for convenience to indicate spatial relationships of components with respect to each other; except as otherwise indicated, orientation with respect to external axes is not critical. For clarity, some known methods and structures have not been described in detail. Methods defined by the claims may comprise steps in addition to those listed, and except as indicated in the claims themselves the steps may be performed in another order than that given. Accordingly, the only limitations are imposed by the claims, not by the drawings or this description.

Some embodiments of the systems and methods described herein may be implemented in various forms of hardware, software, firmware, special purpose processors, or a combination thereof. At least a portion thereof may be implemented as an application comprising program instructions that are tangibly embodied on one or more program storage devices such as hard disks, magnetic floppy disks, RAM, ROM, and CDROM, and executable by any device or machine comprising suitable architecture. Some or all of the instructions may be remotely stored and accessed through a communication facility; for example, execution of remotely-accessed instructions may be referred to as cloud computing. Some of the constituent system components and process steps may be implemented in software, and therefore the connections between system modules or the logic flow of method steps may differ depending on the manner in which they are programmed.

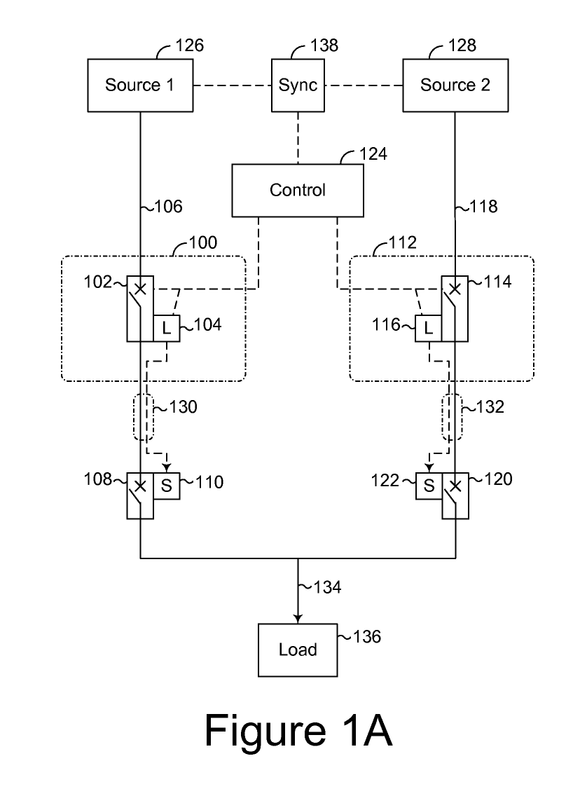

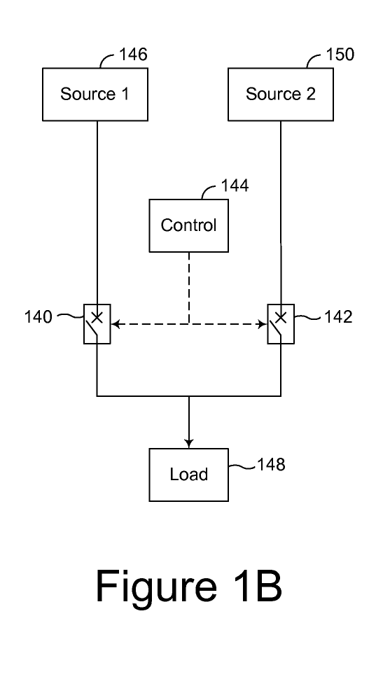

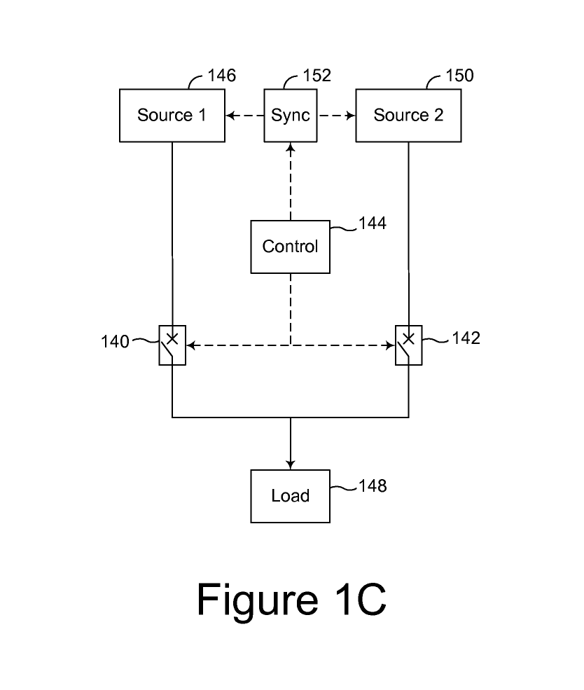

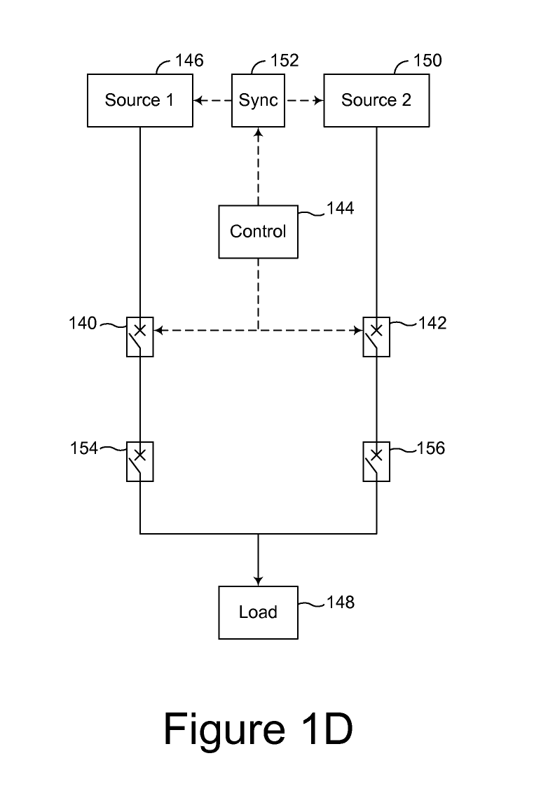

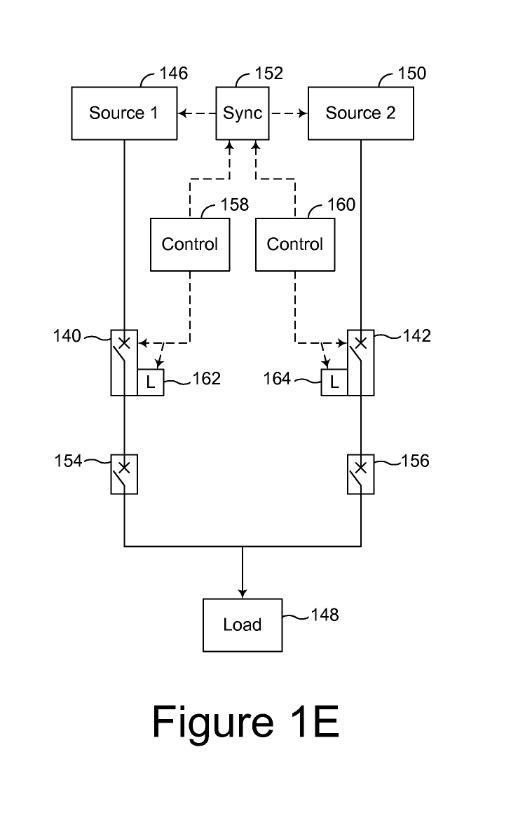

FIG. 1A illustrates an embodiment of an electrical power system providing fault isolation and service continuity. The system includes a first source breaker 102 and lockout relay 104, a first power input 106, and a first load breaker 108 having a shunt trip 110. The first source breaker 102 and lockout relay 104 are in power-providing and trip-controlling communication with the first load breaker 108. The system also includes a second source breaker 114 and lockout relay 116, a second power input 118, and a second load breaker 120 having a shunt trip 122. The second source breaker 114 and lockout relay 116 are in power-providing and trip-controlling communication with the second load breaker 120. The system also includes a controller 124 in communication with the source breakers 102 and 114.

The power input 106 need not take any particular form. In the example of FIG. 1A, the first power input 106 is simply an electrical conductor extending between the first source breaker 102 and a first power source 126. Similarly, the power input 118 is a conductor extending between the second source breaker 114 and a second power source 128. In other examples, the power input might comprise some other kind of power plug, connector, or the like. Either of the power sources may be for example a public utility power line, an auxiliary generator, or some other suitable source of electrical power.

The first source breaker 102 may be located remotely from the first load breaker 108 and may provide power to it through any convenient power transmission medium. In this example power is carried by one or more conductors through a raceway 130. The lockout relay 104 sends a trip signal to the shunt trip 110 through any suitable means, which in this example is another conductor in the raceway 130. Similarly, power and communication conductors from the second source breaker 114 and lockout relay 116 to the second load breaker 120 and shunt trip 122 are carried through a raceway 132. In other examples the lockout relays may communicate with the shunt trips through differently-located conductors or through a data communication system or wirelessly.

In some examples the first source breaker 102 and lockout relay 104 are installed in a first switchboard 100. Similarly, the second source breaker 114 and lockout relay 116 may be installed in a second switchboard 112. The physical locations of source breakers and load breakers in one or more switchboards can be arranged as convenient and is not critical to the functioning of the components and circuits described herein.

In this example a single controller 124 communicates with both source breakers. In other examples the controller may include more than one control unit each in communication with one source breaker. The control units may be physically installed in or adjacent any switchboards or remotely located as may be convenient. The controller may be programmed or otherwise configured to close the first source breaker 102 and open the second source breaker 114 if power is available at the first power input 106 and if the first source breaker 102 is not in a tripped state, and if power ceases to be available at the first power input 106 or if the first source breaker 102 trips, to close the second source breaker 114 and open the first source breaker 102 if power is available at the second power input 118 and if the second source breaker 114 is not in a tripped state.

In some examples the controller 124 also monitors the load breakers 108 and 120, does not close the first source breaker 102 if the first load breaker 108 is tripped, and does not close the second source breaker 114 if the second load breaker 120 is tripped.

The two load breakers 108 and 120 may feed a power output 134. As with the power inputs 106 and 118, the power output 134 may be just a connection point or a conductor, or it may be a receptacle or some other kind of power connector. The power output may be connected to a load 136. The load 136 may be a computer server, a medical appliance, an air conditioner, a chiller, or most any other kind of electrically-powered device.

In some examples a power synchronizer 134 is in communication with the controller 124 to detect when the power sources 126 and 128 are in sync with each other. For example, the synchronizer might detect when both power supplies have the same direct current (DC) output voltage or when they both have the same frequency or phase angle (or both) in the case of alternating current (AC) power.

The functioning of the various components will now be explained in more detail with reference to FIGS. 1B through 1E each of which illustrates some of these components.

FIG. 1B shows those components that make up a breaker transfer pair. The breaker transfer pair is an electrically operable circuit breaker implementation of the more common transfer switch. It can include a first source isolation circuit breaker 140, a second source isolation breaker 142, and a control 144. The first source isolation breaker 140 can connect a first power source 146 to a load 148, and the second source isolation breaker 142 can connect a second power source 150 to the load 148. The power sources 146 and 150 can take various forms, and in some cases may be AC single- or multi-phase or DC sources having any voltage or amperage ratings.

The control 144 can electrically operate the source isolation breakers 140 and 142 so as to feed the load 148 from either of the two power sources 146 and 150. In some embodiments these power sources can be operated as primary and secondary sources or normal and emergency sources. However, for purposes of this description, the power sources are simply referred to as first and second power sources or as Source 1 and Source 2. The control 144 can monitor the status of the breaker transfer pair and of both power sources for acceptability to serve the load. For robustness, the control 144 can include an interlock circuit or mechanism to prevent both of the source isolation breakers from being closed at the same time. In some examples the control 144 includes or is part of a programmable logic controller (PLC).

As an example of operation of the circuit of FIG. 1B, consider the circuit to be in a state in which the first power source 146 is feeding the load 148 through the first source isolation breaker 140 and the second source isolation breaker 142 is in an open state (a state in which the second power source 150 is disconnected from the load). The control 144 can sense if the power provided by the first power source 146 is unacceptable, for example if the voltage is too low or too high with reference to a threshold, or if the phases of a multi-phase power supply are out of balance, or if the frequency is wrong. The control 144 can also sense if the power available from the second power source 150 is acceptable.

By way of example, the control 144 can perform this sequence of operations:
1. Open the first source isolation breaker 140.
2. Optionally, wait for a period of time before performing other operations, to allow residual voltage to decay at the load 148. For example, residual voltage can last as much as a second for an inductive load such as an input transformer of an uninterruptible power supply (UPS) or several seconds in the case of a large motor load such as a chiller motor.
3. Close the second source isolation breaker 142.

The control 144 can perform the reverse of the above sequence of operations if it subsequently determines that the power provided by the second power source 150 is unacceptable, but the power provided by the first power source 146 is acceptable. More specifically, the control 144 can perform the following sequence of operations:

1. Open the second source isolation breaker 142.

2. Optionally, wait for a period of time before performing other operations.

3. Close the first source isolation breaker 140.

The circuit can in some cases include additional components, or the control 144 can perform other operations or include other circuitry.

FIG. 1C illustrates an enhancement that includes source synchronization. The components 140 through 150 shown in FIG. 1C are similar to the components with the same reference numerals shown in FIG. 1B and will not be further described. The circuit of FIG. 1C is enhanced by providing an ability to synchronize operation of the first and second power sources 146 and 150. This circuit includes a synchronizing component 152 connected to the power sources 146 and 150 and the control 144. The synchronizing component 152 provides a way to synchronize operation of the power sources. Synchronization of the power sources can include, for example, monitoring or adjusting the voltage, the frequency, or the phase angle of one or both of the power sources to ensure that the respective parameters of the power sources are matched or are within acceptable limits. When the power sources are synchronized it is possible at least temporarily to close both the first and the second source isolation breakers 140 and 142 at the same time. In the absence of source synchronization, closing both of the source isolation breakers may draw significant current from one of the power sources to the other through the common point of connection to the load. The current draw would typically result in an over-current condition that would trip one or both of the source isolation breakers 140 and 142.

As an example of the operation of the circuit of FIG. 1C, consider the circuit to be in a state in which the first power source 146 is feeding the load 148 through the first source isolation breaker 140 while the second source isolation breaker 142 is in an open state. The control 144 may sense that the power available from the first and second power sources 146 and 150 is acceptable. For purposes such as maintenance of the first power source 146, or the application of Zipper Logic^{SM} functionality (to be described presently), or the application of Fix-One Break-One^{SM} logic functionality (also to be described presently), the control 144 may perform the following sequence of operations:
1. Ensure that the first and second power sources are in sync or have been synchronized by the synchronizing component 152.
2. Close the second source isolation breaker 142.
3. Optionally, wait for a period of time before performing other operations, to allow power at the load 148 to stabilize. Typically this period of time would be less than 3 seconds and in some cases could be as short as 0.1 seconds.
4. Open the first source isolation breaker 140.

If the first power source 146 is once again brought online or made available, and the control 144 subsequently determines that the power available from both sources is acceptable, the control 144 may perform the following sequence of operations to transfer the load 148 back to the first power source 146:
1. Ensure that the first and second power sources are in sync or have been synchronized by the synchronizing component 152.
2. Close the first source isolation breaker 140.
3. Optionally, wait for a period of time before performing other operations, to allow power at the load 148 to stabilize.
4. Open the second source isolation breaker 142.

The circuit described with reference to FIG. 1C can in some cases include additional components, or the control 144 can perform other operations or include other circuitry.

One advantage offered by the circuit of FIG. 1C over that of FIG. 1B is that the load 148 can be switched from one power source to the other without being de-energized. If the load includes an uninterruptable power supply (UPS), the UPS can be transferred from one power source to the other without the UPS having to use battery power. If the load includes a mechanical element, for example a chiller or a computer room air conditioning (CRAC) unit, the load can be transferred without having to perform a restart procedure.

FIG. 1D illustrates an enhancement that includes power source isolation. The components 140 through 152 shown in FIG. 1D are similar to the components with the same reference numerals shown in FIGS. 1B and 1C and will not be further described. The circuit of FIG. 1D is enhanced over the circuits of FIGS. 1B and 1C by providing source and load breaker pairs that prevent power from being conducted to the backside of a source breaker, thereby permitting a power source to be safely taken offline for maintenance or other purposes.

The circuit of FIG. 1D includes a first load isolation breaker 154 and a second load isolation breaker 156. The first source isolation breaker 140 is coupled in series with the first load isolation breaker 154; the series combination of breakers 140 and 154 connects the first power source 146 to the load 148. The second source isolation breaker 142 is coupled in series with the second load isolation breaker 156, with the series combination of breakers 142 and 156 connecting the second power source 150 to the load 148. Typically the source and load breakers are physically separated from each other by a distance that may be as much as several hundred meters depending on desired locations of the various components, but no particular separation is required.

The load isolation breakers 154 and 156 may be manually operated, normally-closed circuit breakers. Optionally, the circuit can include logic or a hard wired interlock, for example a combination of control wires or circuitry or both, associated with one or more of the breakers 140, 142, 154, and 156 and the control 144 to auto-open one of the source isolation breakers 140 or 142 if the respective downstream load isolation breaker 154 or 156 is opened for any reason, either manually or by protective trip.

The control 144 can electrically operate the first and second source isolation breakers 140 and 142 while the first and second load isolation breakers 154 and 156 are closed, feeding the load 148 from either of the two power sources. The control 144 can monitor the status of the breakers and the power sources to be sure they can serve the load 148. With both load isolation breakers 154 and 156 closed, the operation of the circuit is similar to that already described with reference to FIGS. 1B and 1C.

The circuit of FIG. 1D can prevent conduction of voltage to the backside of (or isolate power from) one of the source isolation breakers so that the respective power source can be safely taken offline for maintenance or other purposes. For example, if it is desired to remove the second power source 150 from service while the first power source 146 is feeding the load 148, the second load isolation breaker 156 can be opened, thereby allowing power to be fed to the load 148 from the first power source 146, but preventing voltage from being conducted to the backside of the second source isolation breaker 142. If the second power source 150 and the second source isolation breaker 142 are physically separate from the load isolation breakers 154 and 156, the second power source 150 and the second source isolation breaker 142 can be completely de-energized. Without the second load isolation breaker 156, power could back-feed from one power source to the other.

The source isolation breakers 140 and 142 may be electrically operated, either automatically by the control 144 or semi-automatically in response to an input received via a human-machine interface (HMI) such as a touch screen or keypad. The source isolation breakers 140 and 142 can also be operated in response to input received from a remote computer connected to the control 144 by a cable, bus, or network. The load isolation breakers 154 and 156 can be manually operated by pushing a mechanical push button or throwing a lever arm, or electrically-opened by shunt trip as described above.

FIG. 1E illustrates an enhancement that includes redundant control. The components 140 through 156 shown in FIG. 1E are similar to the components with the same reference numerals shown in FIGS. 1B, 1C and 1D and will not be further described. In the circuit of FIG. 1E, the single control 144 has been replaced by separate controls 158 and 160. Each of the controls 158 and 160 can electrically operate both the first and second source isolation breakers 140 and 142. For purposes of emergency response to a power failure, the circuit of FIG. 1E is single-failure proof at the power source. That is, failure or loss of power to either one of the controls 158 and 160 does not result in an inability to operate the source isolation breakers 140 and 142 and provide power to the load 148. This is in contrast to the circuits of FIGS. 1B, 1C and 1D in which a single control 144 operates the first and second source isolation breakers 140 and 142.

By means of either one of the control systems 158 and 160 electrically operating the first and second source isolation breakers 140 and 142 while the first and second load isolation breakers 154 and 156 are closed, the load 148 can be fed from either of the two power sources 146 and 150. For example, the first control system 158 can monitor the status of the breakers 140 and 142 and both power sources for acceptability to serve the load. In some cases the first control system 158 can monitor the second source isolation breaker 142 and the second power source 150 directly. In other cases, the first control 158 can receive signals or information regarding the operation of the second source isolation breaker 142 and the second power source 150 from the second control 160. Failure to receive information from the second control system 160 can be interpreted by the first control 158 as a failure of one or both of the second source isolation breaker 142 and the second power source 150. The second control system 160 can be operated in a similar manner. In some examples either or both of the controls 158 and 160 include or are part of one or more PLCs.

But for the option to use either the first control 158 or the second control 160 to operate the first and second source isolation breakers 140 and 142, the circuit of FIG. 1E can operate in a manner similar to the circuits of FIGS. 1B, 1C and 1D. A master control system such as a master PLC (not shown) may coordinate operation of the controls 158 and 160, as well as pass operator commands on to the controls 158 and 160. Such a master control system can also coordinate the operation of other controls including controls used to manage power applied to other loads.

A potential problem can arise if an electrical fault occurs between the source and load isolation breakers 140 and 154 or between the breakers 142 and 156, especially if the source and load isolation breakers are separated from each other by a distance, installed in separate equipment enclosures. For example, when the first source isolation breaker 140 is closed and the second source isolation breaker 142 is open, and with both of the load isolation breakers 154 and 156 closed, the first source isolation breaker 140 can automatically trip upon the occurrence of a fault between the first source isolation breaker 140 and the first load isolation breaker 154. This trip can be referred to as a protective trip. If a protective trip occurs, an optional lockout relay 162 associated with the first source isolation breaker 140 can be actuated. When actuated, the lockout relay 162 prevents any change from the first source 146 to the second source 150 either manually or automatically by the control 158 or the control 160. As a result, the lockout relay 162 not only prevents the associated source isolation breaker 140 from being reclosed, but also prevents the second source isolation breaker 142 from closing. This interlock prevents the second source isolation breaker 142 from closing on a known fault but at the cost of de-energizing the load. An optional lockout relay 164 associated with the second source isolation breaker 142 operates in a similar manner.

The de-energizing of the load that can result from the use of lockout relays as described above with reference to FIG. 1D is avoided by the use of shunt trips as shown in FIG. 1A. In the circuit of FIG. 1A, the single control 124 may be replaced with dual control units similar to the controls 158 and 160 of FIG. 1E. The circuit of FIG. 1A thus includes all of the features described above with reference to FIGS. 1B through 1E. In addition, as briefly noted above, the circuit of FIG. 1A can provide logic or a hard wired interlock to automatically open one of the load isolation breakers 108 and 120 if the respective upstream source isolation breaker 102 or 114 is opened by protective trip. For example, if the first source isolation breaker 102 sustains a protective trip, it can actuate its lockout relay 104 which in turn automatically opens the load isolation breaker 108 by actuating the electrically operated shunt trip 110 associated with the load isolation breaker 108. In this case, no interlock is needed from the lockout relay 104 to the second source isolation breaker 114.

By way of example, the circuit of FIG. 1A can perform the following sequence of operations:
1. The first source isolation breaker 102 can open as a result of a protective trip.
2. The protective trip of the source isolation breaker 102 can actuate the lockout relay 104.
3. The lockout relay 104 can actuate the shunt trip 110 associated with the first load isolation breaker 108, thereby causing the first load isolation breaker 108 to open. The shunt trip 110 can prevent closure of the first load isolation breaker 108 as long as the first source isolation breaker 102 remains tripped and the lockout relay 104 remains actuated. Any attempt to manually close the first load isolation breaker 108 under these conditions would result in a trip-free response, which prevents the first load isolation breaker 108 from closing.
4. The control 124, or one of the controls if more than one control is used, can determine that both the load isolation breaker 108 and the source isolation breaker 102 are open and can restore power to the load 136 from the second power source 128 through the second source and load isolation breakers 114 and 120. A time delay can be provided as described above to allow residual voltage at the load to decay. Often, a fault that causes the first source and load isolation breakers 102 and 108 to trip will not impact the restoration of power from the second power source 128. However, in some cases the fault that led to tripping of the isolation breakers 102 or 108 or both will impact the ability to restore power to the load from the second power source 128. In these cases, the second source isolation breaker 114 will trip on the fault, thereby activating the lockout relay 116 associated with the second source isolation breaker 114, and then no other attempt will be made to re-energize the load. This type of single try to re-energize the load can be useful when service continuity is deemed more important than equipment protection.
5. After repair of the fault between the first source and load isolation breakers 102 and 108, the isolation breakers and lockout relays can be manually reset, thereby restoring availability of power from the first power source 126.

The lockout relay 116, which is associated with the second source isolation breaker 114, and the shunt trip 122, which is associated with the second load isolation breaker 120, can be used similarly. In this manner, this circuit can provide both fault isolation and service continuity.

The electrically-operated source isolation breakers and manually-operated load isolation breakers shown in FIGS. 1A through 1E may be replaced with transfer switches. In at least some embodiments, however, maintainability and fault isolation may be compromised if this is done.

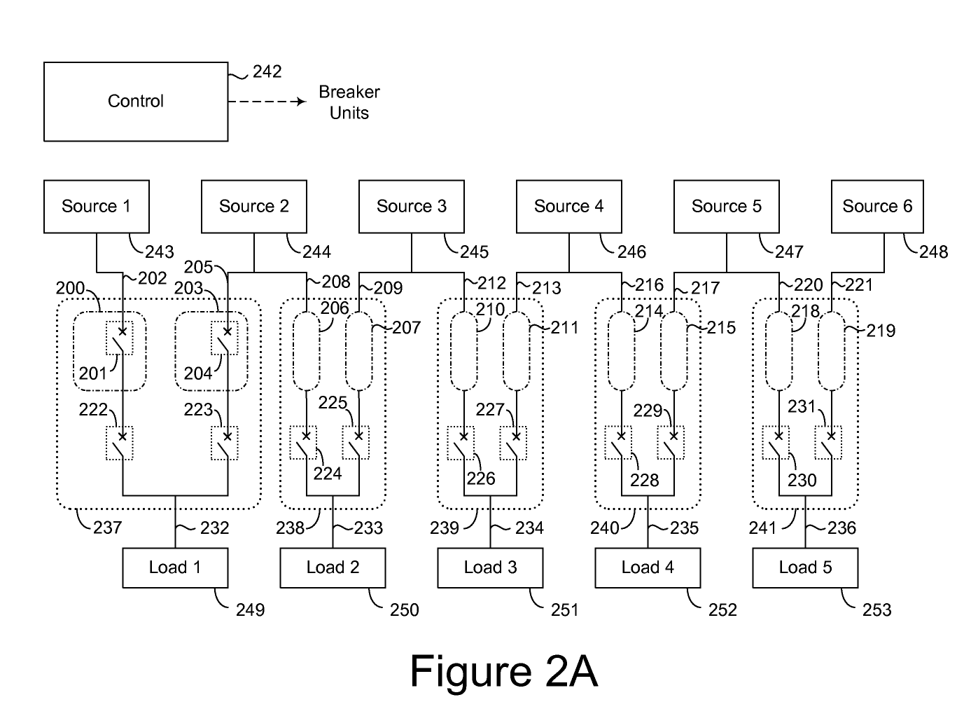

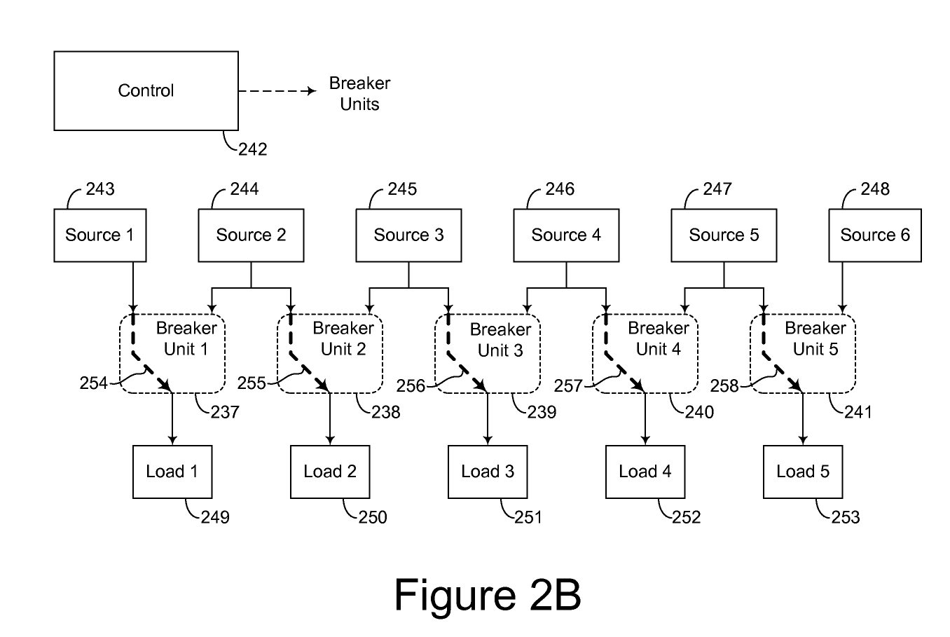

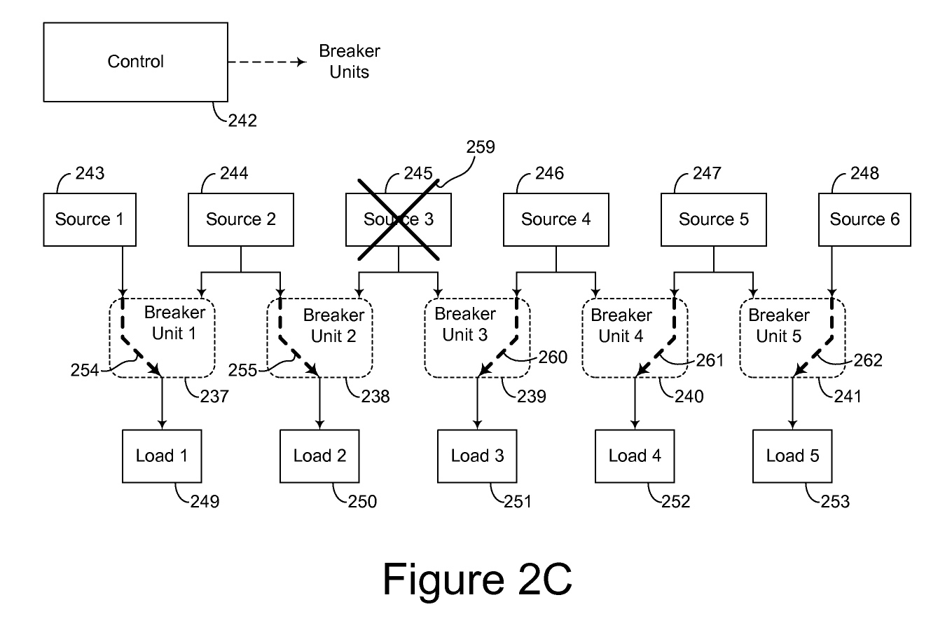

FIG. 2A illustrates an embodiment implementing Zipper Logic^{SM} functionality with more than two switchboards. This example includes a plurality of pairs of switchboards. One pair includes a first switchboard 200 having a first source breaker 201 and lockout relay (not shown) and a first power input 202, and a second switchboard 203 having a second source breaker 204 and lockout relay (not shown) and a second power input 205. Other pairs include switchboards 206 and 207 with power inputs 208 and 209, switchboards 210 and 211 with power inputs 212 and 213, switchboards 214 and 215 with power inputs 216 and 217, and switchboards 218 and 219 with power inputs 220 and 221. Other examples may have more or fewer pairs. Although in this example the source breakers and their lockout relays are shown as mounted in switchboards, such mounting is not necessary. Each switchboard in this example is similar to the switchboard 100 of FIG. 1A and has similar components, and may have other components also.

The example of FIG. 2A also includes a plurality of pairs of load breakers, each load breaker having a shunt trip similar to the shunt trip 110 in FIG. 1A. For clarity the shunt trips are omitted from FIG. 2A. Each pair of switchboards is in power-providing and trip-controlling communication with one of the pairs of load breakers. For example, the switchboard 200 is in communication with a load breaker 222, the switchboard 203 is in communication with a load breaker 223, and so on for load breakers 224 through 231. The load breakers 222 and 223 are in power-providing communication with a power output 232, and so on for power outputs 233 through 236. The switchboards 200 and 203, and the load breakers 222 and 223, are enclosed in a dotted line in FIG. 2A and collectively referred to as a breaker unit 237, but this grouping is only for convenience of reference in this discussion and does not necessarily correspond with any physical or electrical configuration of the switchboards, breakers, or other components. Similarly, the switchboards 206 and 207 and the load breakers 224 and 225 are referred to as a breaker unit 238, and so on for breaker units 239 through 241.

In some examples, individual switchboards such as 203 and 206, 207 and 210, 211 and 214, or 215 and 218, as shown in FIG. 2A will be combined into a single switchboard for all breakers connected to a single power source—203 and 206 in one switchboard connected to power source 244, 207 and 210 in one switchboard connected to power source 245, and so on. Similarly the two load breakers connected to a single load, such as 222 and 223 connected to 249, 224 and 225 connected to 250, 226 and 227 connected to 251, 228 and 229 connected to 252, or 230 and 231 connected to 253 may be enclosed in a single switchboard—222 and 223 in one switchboard connected to load 249, 224 and 225 in one switchboard connected to load 250, and so on. Separate or combined switchboards are only for convenience of installation and do not affect the operation as described above and below.

A control 242 is shown as communicating with all the breakers. A single control is shown, but the control 242 may actually comprise a plurality of controls. For example, each breaker unit may have its own control or, as shown in FIG. 1E, each source switchboard may have its own control. These various controls may communicate with each other by any suitable means such as Wi-Fi or a digital cable. The controls may be implemented as one or more PLCs. Such PLCs may be switchable between an automatic mode in which the PLC controls its breakers and a manual mode in which the breakers can be electrically operated through pushbuttons subject to interlocks as already described. The breakers themselves may also have manual controls that override interlocks except a continuous signal to a shunt trip. Each PLC can monitor more than one transfer breaker pair in one or more switchboards, thereby providing redundancy in case a PLC fails.

In this example the power input 202 is in power-receiving communication with a first power source 243. The power inputs 205 and 208 are in power-receiving communication with a second power source 244, the power inputs 209 and 212 are in power-receiving communication with a third power source 245, the power inputs 213 and 216 are in power-receiving communication with a fourth power source 246, the power inputs 217 and 220 are in power-receiving communication with a fifth power source 247, and the power input 221 is in power-receiving communication with a sixth power source 248. The power output 232 is in power-providing communication with a load 249, the power output 233 with a load 250, and so on for loads 251 through 253.

More source breakers and load breakers may be provided if there are more power sources and more loads.

In this embodiment, no power source need have the capacity to service more than one load. The first load 249 can be serviced by either the first power source 243 or the second power source 244, the second load 250 by either the second power source 244 or the third power source 245, and so on. If power ceases to be available from any power source or if any source breaker trips, the controller is in communication with the source breakers to cause the source breakers to establish electrical power connections between the remaining power sources and loads in sequence such that no load is connected to more than one source at any time.

As shown in FIG. 2B, the first load 249 might initially be powered by the first power source 243, the second load 250 by the second power source 244, and so on, with the sixth power source 248 being idle. This is indicated by a dashed line 254 showing a connection through the first breaker unit 237 from the first power source 243 to the first load 239, and by dashed lines 255 through 258 indicating similar connections between the second through fifth power sources and the second through fifth loads, respectively.

If a power source fails, the following sequence of operations occurs:
1. Referring to FIG. 2C, assume the third power source 245 fails, as indicated by an “X” 259 over the third power source. The control 242 checks to find out whether either the adjacent second power source 244 or the adjacent fourth power source 246 is available to power the third load 251.
2. Power sources 244 and 246 are powering the second and fourth loads 250 and 252, respectively, and therefore neither is available. The control 242 thereupon checks to find out whether either the next adjacent first power source 243 or the next adjacent fifth power source 247 is available to power the third load 251. As discussed in more detail above, the control 242 may comprise one or several separate control units.
3. Power sources 243 and 247 are powering the first and fifth loads 249 and 253, respectively, and therefore neither is available. There is no adjacent power source to the first power source 243, and the control 242 thereupon checks to find out whether the next adjacent power source 248 is available.
4. The power source 248 has no load and therefore is available. The fifth breaker unit 241 thereupon switches the fifth load 253 from the fifth power source 247 to the sixth power source 248, freeing the fifth power source 247. This switching is carried out as described above with reference to FIGS. 1A through 1E.
5. The fourth breaker unit 240 thereupon switches the fourth load 252 from the fourth power source 246 to the fifth power source 247, freeing the fourth power source 246.
6. Now the third breaker unit 239 switches the third load 251 from the failed third power source 245 to the fourth power source 246, resulting in all loads again receiving power. This sequential switching of loads is referred to as Zipper Logic^{SM}.

The resulting state of affairs is indicated in FIG. 2C by a dashed line 260 showing a connection through the third breaker unit 239 from the fourth power source 244 to the third load 251, and by dashed lines 261 and 262 indicating similar connections between the fifth and sixth power sources 247 and 248 and the fourth and fifth loads 252 and 253, respectively.

In more traditional power systems, a given number of loads would require two power sources per load to be sure each load had a backup power supply if needed. An advantage of the circuit of FIGS. 2A through 2C is that the number of required power sources is reduced to one more than the number of loads, representing an approximate saving of 40% of the cost of power sources for the examples shown. The savings could be more for larger systems.

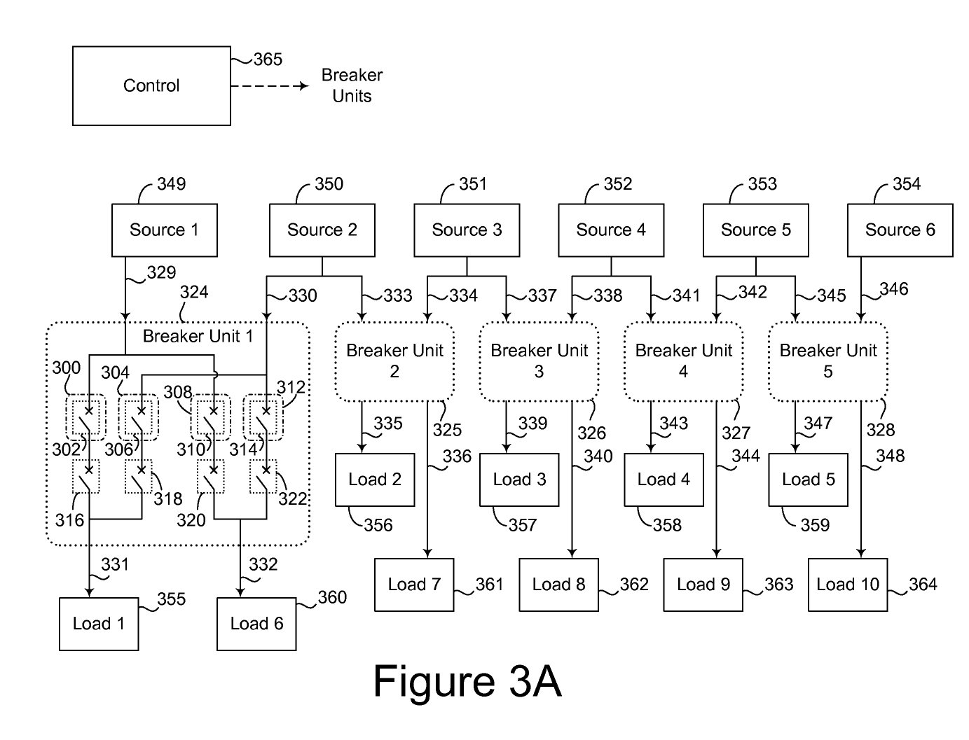

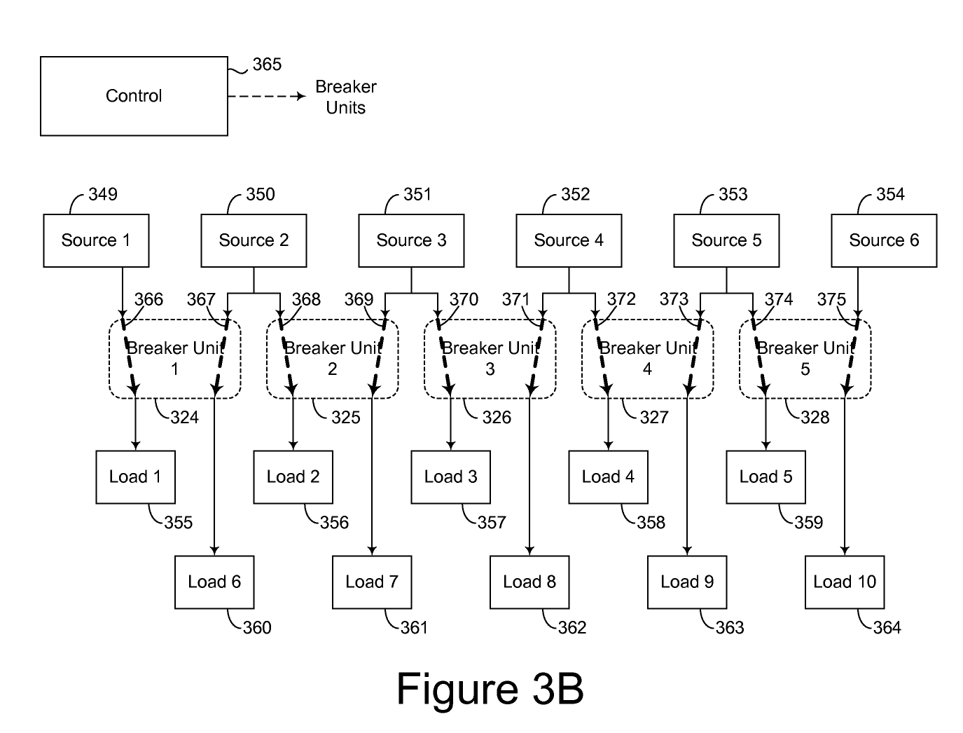

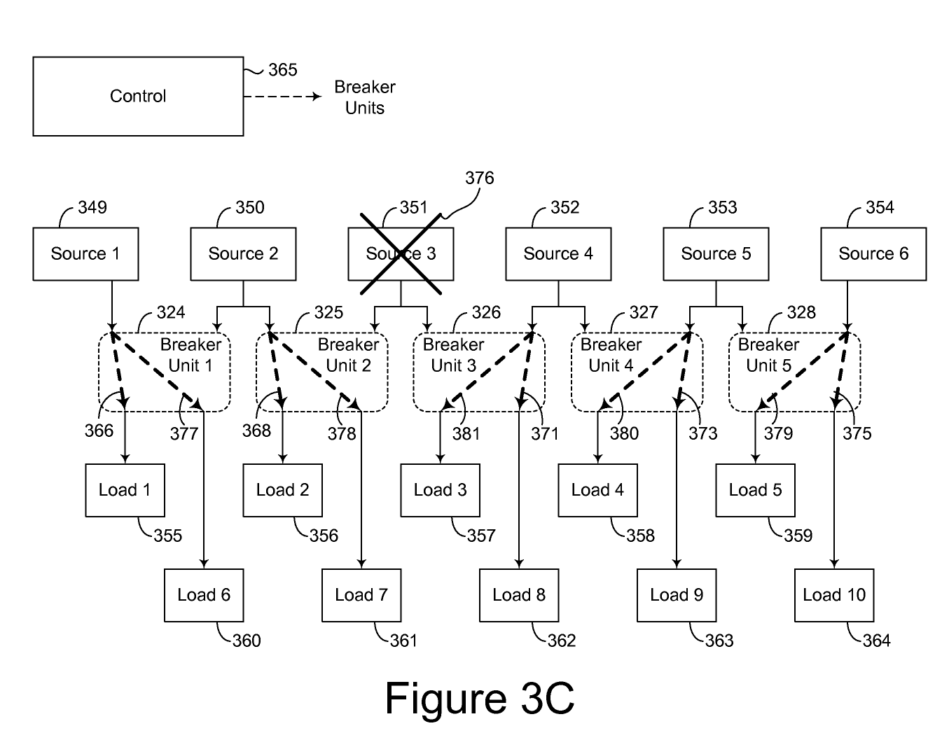

FIG. 3A illustrates another embodiment implementing Zipper Logic^{SM} functionality with more than two switchboards in which each power source can service two loads. This example includes a plurality of switchboards each similar to the switchboard 100 of FIG. 1A. A switchboard 300 includes a source breaker 302 and lockout relay. Similarly, a switchboard 304 includes a source breaker 306 and lockout relay, a switchboard 308 includes a source breaker 310 and lockout relay, and a switchboard 312 includes a source breaker 314 and lockout relay. For clarity, the lockout relays are not shown. Also included are a plurality of load breakers 316, 318, 320, and 322, each having a shunt trip. The source breaker 302 is in power-providing and trip-controlling communication with the load breaker 316, and so on for the other source and load breakers. As noted above, whether or not source breakers are placed in switchboards, and whether one or many components are installed in any switchboard, are matters of convenience and do not affect circuit operation.

The switchboards and load breakers are arranged in groups of four. The switchboards 300, 304, 308 and 312, and the load breakers 316, 318, 320, and 322 are arranged in a group referred to as a breaker unit 324. Similarly, other groups of four switchboards and four load breakers are arranged as breaker units 325, 326, 327 and 328. These groupings are only for convenience in this discussion and do not necessarily indicate a required configuration. Separate or combined switchboards are only for convenience of installation and do not affect the operation as described above and below. The first and third switchboards 300 and 308 have a common first power input 329, and the second and fourth switchboards 304 and 312 have a common second power input 330. The first and second load breakers 316 and 318 have a common power output 331, and the third and fourth load breakers 320 and 322 have a common power output 332. Similarly the second breaker unit 325 has first and second power inputs 333 and 334 and power outputs 335 and 336, and so on for the third, fourth, and fifth breaker units 326, 327, and 328.

A first power source 349 is in power-providing communication with the power input 329. A second power source 350 is in power-providing communication with the power inputs 330 and 333, a third power source 351 with the power inputs 334 and 337, a fourth power source 352 with the power inputs 338 and 341, a fifth power source 353 with the power inputs 342 and 345, and a sixth power source 354 with the power input 346.

First through fifth loads 355 through 359 are in power-receiving communication with the power outputs 331, 335, 339, 343, and 347, respectively. Similarly, sixth through tenth loads 360 through 364 are in power-receiving communication with the power outputs 332, 336, 340, 344, and 348, respectively. More breaker units may be provided if there are more power sources and loads.

A control 365 is shown as communicating with all the breakers. A single control is shown, but the control 365 may actually comprise a plurality of controls with any suitable communication arrangement as discussed above in more detail.

No power source has the capacity to service more than two loads. The first load 335 can be serviced by either the first power source 349 or the second power source 350, as can the sixth load 360. The second load 356 can be serviced by either the second power source 350 or the third power source 351, as can the seventh load 361, and so on. If power ceases to be available from any power source or if any source breaker trips, the controller 365 is in communication with the source breakers to cause the source breakers to establish electrical power connections between the remaining power sources and loads in sequence such that no power source is connected to more than two loads at any time.

As shown in FIG. 3B, the first load 355 might initially be powered by the first power source 349, the second and sixth loads 356 and 360 by the second power source 350, and so on, with the tenth load 364 powered by the sixth power source 354. The first and sixth power sources each are powering one load and the other power sources are each powering two loads. These connections are indicated by a dashed line 366 showing a connection through the first breaker unit 324 from the first power source 349 to the first load 355, and by dashed lines 367 through 375 indicating similar connections between the second through sixth power sources and the second through tenth loads, respectively.

If a power source fails, the following sequence of operations occurs:
1. Referring to FIG. 3C, assume the third power source 351 fails, as indicated by an “X” 376 over the third power source. The control 365 checks to find out whether either of the adjacent power sources 350 or 352 is available to power the third and seventh loads 357 and 361.
2. The power sources 350 and 352 are powering the second and sixth loads 356 and 360, and the fourth and eighth loads 358 and 362, respectively, and therefore neither is available. The control 365 thereupon checks to find out whether either of the next adjacent power sources 349 or 353 is available.
3. The first source 349 is powering only the first load 355 as indicated by the dashed line 366 and therefore has capacity for one more load. The control thereupon switches the sixth load 360 from the second source 350 to the first source 349 as indicated by a dashed line 377. The second source is still powering the second load 359 as indicated by the dashed line 368, so the seventh load 361 is switched from the third source 351 to the second source 350 as indicated by a dashed line 378.
4. The fifth source 353 is powering the fifth and ninth loads 359 and 363 and therefore is not available. The control thereupon checks the next adjacent source, being the sixth source 354.
5. The sixth source 354 is powering only the tenth load 364 as indicated by the dashed line 375 and therefore has capacity for one more. The control thereupon switches the fifth load 359 from the fifth source 353 to the sixth source 354 as indicated by a dashed line 379. The fifth source is still powering the ninth load 363 as indicated by the dashed line 373, so the fourth load 358 is switched from the fourth source 352 to the fifth source 353 as indicated by a dashed line 380. The fourth source 352 is still powering the eighth load 362 as indicated by the dashed line 371, so the third load 357 is switched from the third source 351 to the fourth source 352 as indicated by a dashed line 381, resulting in both the third and seventh loads 357 and 361 again having power.
6. The switching is carried out as described above with reference to FIGS. 1A through 1E.

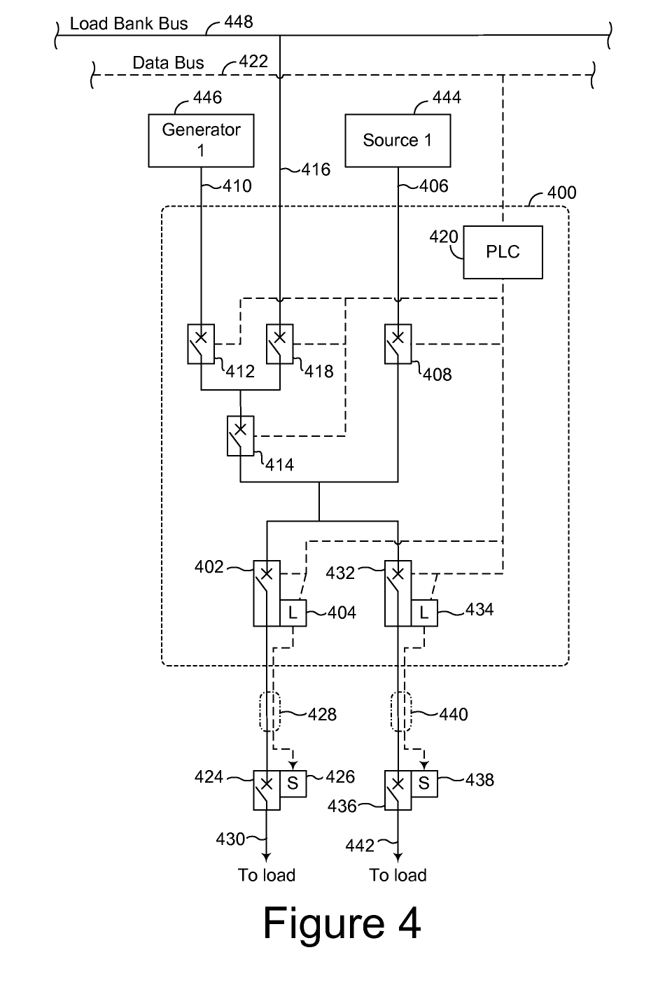

In another example, as shown in FIG. 4, a main switchboard 400 has a source isolation breaker 402 and lockout relay 404. A first power input 406 is in power-providing communication with the source isolation breaker 402 through a utility breaker 408. An auxiliary input 410 is in power-providing communication with the source isolation breaker 402 through an auxiliary breaker 412 and a tie breaker 414. A load bank input 416 is in communication with the source isolation breaker 402 through a load bank breaker 418 and the tie breaker 414. A control which may be a programmable logic controller (PLC) 420 is in communication with the breakers. In some examples the PLC 420 is in communication with other PLCs or some other data and control system through a data bus 422. As in some of the examples discussed above, a single control may perform the control functions for more than one switchboard.

A load isolation breaker 424 is in power-receiving communication with the source isolation breaker 402. The load isolation breaker 424 has a shunt trip 426. The lockout relay 404 is in controlling communication with the shunt trip 426. In some examples the power and controlling communications between the main switchboard 400 and the load isolation breaker 424 are carried over conductors in a raceway 428. The load isolation breaker 424 is in power-providing communication with a power output 430.

In some examples the switchboard 400 has a second source isolation breaker 432 and lockout relay 434 in power-receiving communication with the utility and tie breakers 408 and 414. A second load isolation breaker 436 and shunt trip 438 are in communication with the second source isolation breaker 432, for example through a raceway 440. The second load isolation breaker 432 is in power-providing communication with a power output 442. Power outputs 430 and 442 are not two sources to the same load, such as from breakers 316 and 318 to load 355 in FIG. 3A. They are similar to the power delivery from breakers 316 and 320 in FIG. 3A, supplied from a common source 349, connected to two different loads 355 and 360

The control 420 is in communication with the breakers to close the utility breaker 408 if power is available from a first power source 444 connected to the first power input 406, for example public utility power, to provide power to the source isolation breaker 402 and, if present, to the second source isolation breaker 432. If power is not available, or becomes unavailable from the first power source 444, the control 420 opens the utility breaker 408 and closes the auxiliary and tie breakers 412 and 414 to provide power from an auxiliary power source such as a generator 446 to the source isolation breakers 402 and 432. In some examples the control 420 causes the generator to start prior to closing auxiliary breaker 412. If power is not available from the generator 446 but is available from a load bank bus 448, the control 420 closes the tie and load-bank breakers 414 and 418 to provide power from the load bank bus 448 to the source isolation breakers 402 and 432. Only one of the source isolation breakers is closed at any one time, so no more than one load is powered from the source isolation switchboard 400. In some examples, if power is not available from either the first power source 444 or the generator 446, the control 420 may locate another generator that is not being used and may cause it to start and be switched onto the load bank bus 448 to provide power to the source isolation breakers. This is an example of Fix-One Break-One^{SM} logic.

As in the examples discussed above, the various components of this example need not be installed in one switchboard and may instead be mounted in other ways without affecting operation of the circuit.

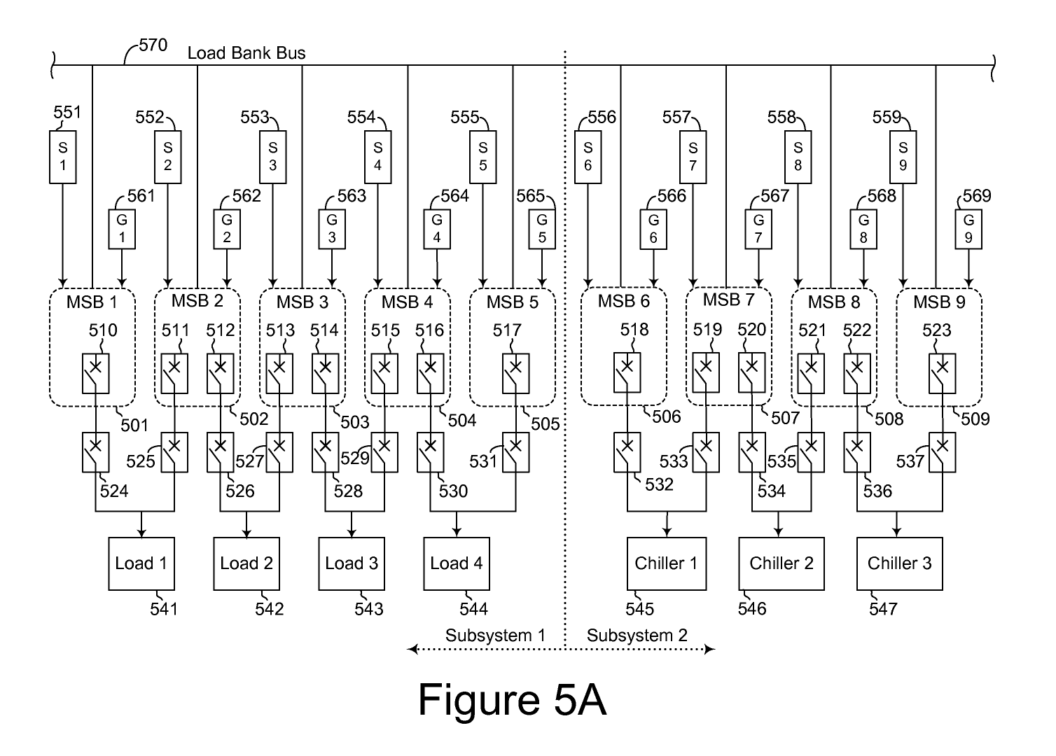

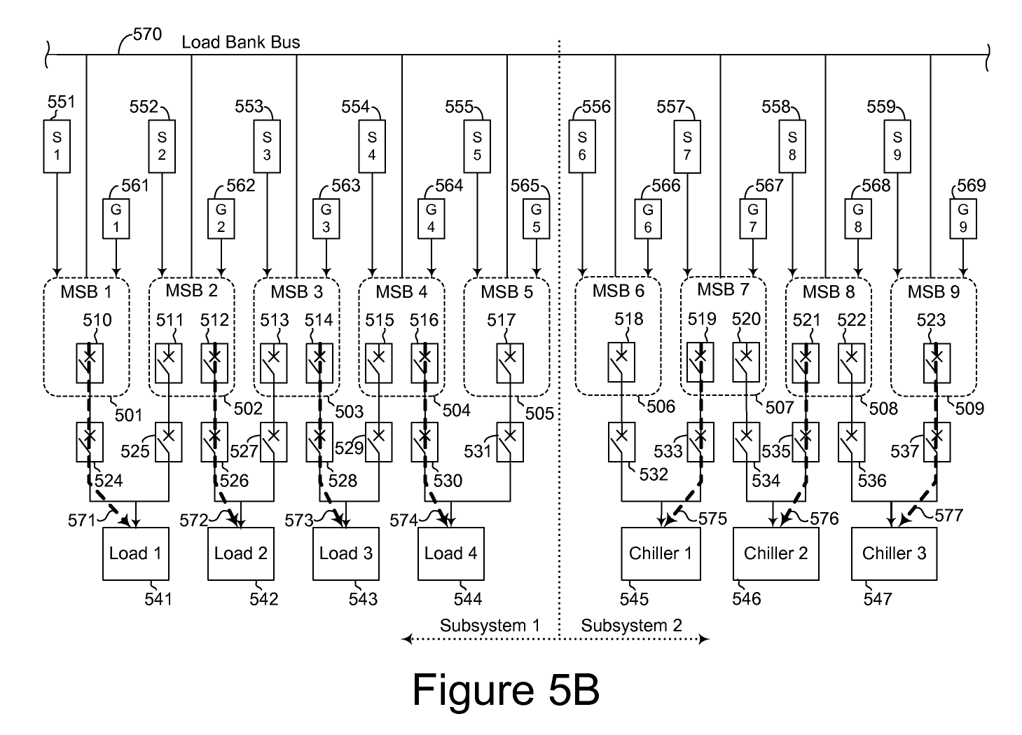

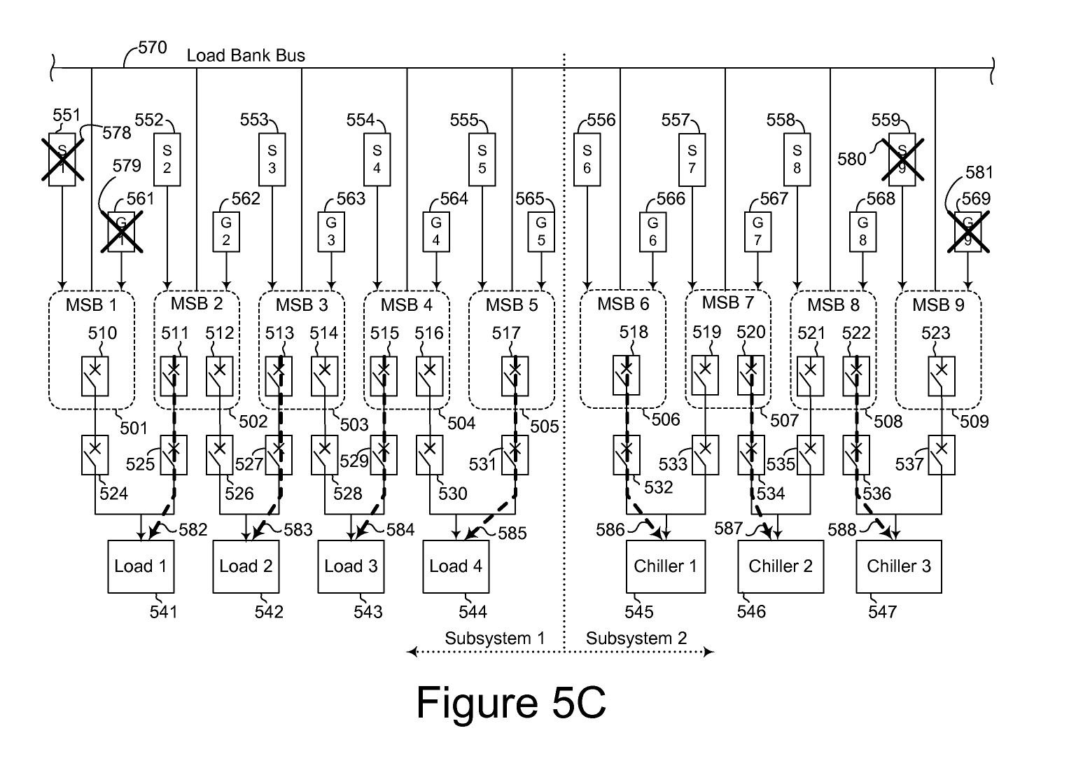

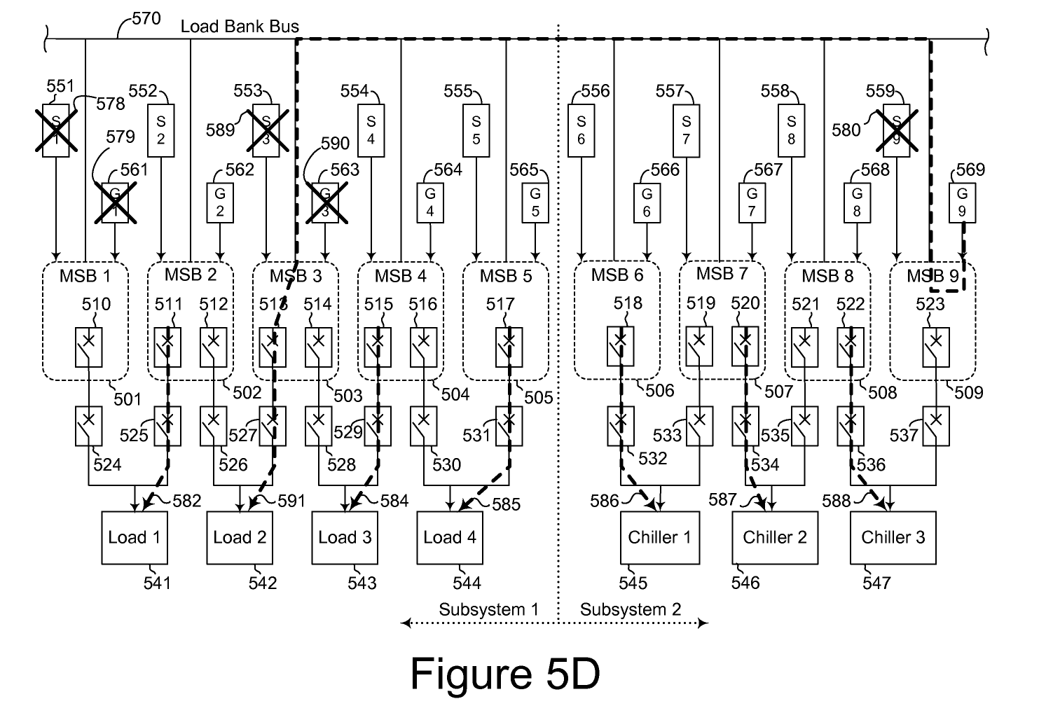

FIG. 5A shows an electrical power system including two subsystems. The first subsystem has five main switchboards (MSBs) 501 through 505, and the second subsystem has four MSBs 506 through 509. Each MSB is similar to the MSB 400 shown in FIG. 4 as discussed above. The first MSB 501 has one source isolation breaker 510 similar to the source isolation breaker 402. The second MSB 502 has two source isolation breakers 511 and 512, the third MSB 503 two source isolation breakers 513 and 514, the fourth MSB 504 two source isolation breakers 515 and 516, the fifth MSB 505 one source isolation breaker 517, the sixth MSB 506 one source isolation breaker 518, the seventh MSB 507 two source isolation breakers 519 and 520, the eighth MSB 508 two source isolation breakers 521 and 522, and the ninth MSB one source isolation breaker 523. The source breakers have lockout relays and the MSBs have other components similar to those shown in FIG. 4, but these are omitted from FIG. 5A for clarity.

The source isolation breakers 510 through 523 connect to load isolation breakers 524 through 537, respectively. The load isolation breakers have shunt trips (not shown). The first two load isolation breakers 524 and 525, which could be enclosed in a single switchboard as described above, connect to a first load 541, the next two load isolation breakers 526 and 527 connect to a second load 542, and so on through a seventh load 547. In this example the loads 541 through 544 are in the first subsystem and may be any kind of load as discussed previously. The loads 545, 546, and 547 are chiller units in this example, but in other examples other kinds of loads could be connected.

The MSB 501 receives power from a primary source 551, the second MSB from a primary source 552, and so on. As discussed previously, the primary sources may be utility power supplies or some other electrical power sources. Similarly, the MSB 501 receives auxiliary power from a source such as a generator 561, the second MSB 502 from a generator 562, and so on. In addition, each MSB is connected to a load bank bus 570. Other components, such as a data bus (not shown) may also be included in one or both subsystems. One controller such as a PLC may control all the MSBs in each subsystem, or one controller may control the MSBs in both subsystems, or each MSB may have its own controller.

As shown in FIG. 5B, the first load 541 might initially be powered through the first MSB 501 and the load breaker 524 from either the power source 551 or the generator 561 as indicated by a dashed line 571, the second load 542 through the second MSB 502 and the load breaker 526 as indicated by a dashed line 572, the third load 543 through the third MSB 503 and the load breaker 528 as indicated by a dashed line 573, and the fourth load 544 through the fourth MSB 504 and the load breaker 530 as indicated by a dashed line 574, with the fifth MSB 505 idle. The first chiller 545 might be powered through the seventh MSB 507 and the load breaker 533 as indicated by a dashed line 575, the second chiller 546 through the eighth MSB 508 and the load breaker 535 as indicated by a dashed line 576, and the third chiller 547 through the ninth MSB 509 and the load breaker 537 as indicated by a dashed line 577, with the sixth MSB 506 idle.

FIG. 5C shows the state of affairs in which both power sources 551 and 561 serving the first MSB 501 have failed as indicated by Xs 578 and 579, respectively, and both power sources 559 and 569 serving the ninth MSB 509 have failed as indicated by Xs 580 and 581. Zipper Logic^{SM} functionality has been employed to switch the loads among the other MSBs in a manner as described above. The first through fourth loads 541, 542, 543, and 544 are now receiving power through the second through fifth MSBs 502 through 505, as indicated by dashed lines 582 through 585, respectively. The first, second, and third chillers 545, 546, and 547 are now receiving power through the sixth through eighth MSBs 506 through 508 as indicated by dashed lines 586 through 588, respectively.

FIG. 5D shows how the situation shown in FIG. 5C changes if the auxiliary power source 569 serving the ninth MSB 509 in the second subsystem is restored, even though the power source 551 and auxiliary power source 561 serving the first MSB 501 are still inoperative, and then both the power source 553 and the auxiliary power source 563 serving the third MSB 503 fail as indicated by Xs 589 and 590. Of course, this same state of affairs could occur if all systems were working and then the power sources 551 and 553 and the auxiliary power sources 561 and 563 all were to fail. In either case, Zipper Logic^{SM} functionality cannot find enough available power sources in the first subsystem to power all the loads in the first subsystem. The control determines that the auxiliary power source 569 in the second subsystem is available. The control thereupon causes that power source 569 to be connected to the load bank bus 570 through the ninth MSB 509, specifically by closing the auxiliary and load bank breakers and opening the tie breaker of the ninth MSB 509. The control also causes the load bank bus 570 to be connected to provide power to the second load 542 through the load bank and tie breakers of the third MSB 503, as indicated by a dashed line 591. In this way, even though two power sources in the first subsystem have failed, all first-subsystem loads are receiving power because power is being drawn from the auxiliary power source 569 in the second subsystem. This is an example of Fix-One Break-One^{SM} logic.

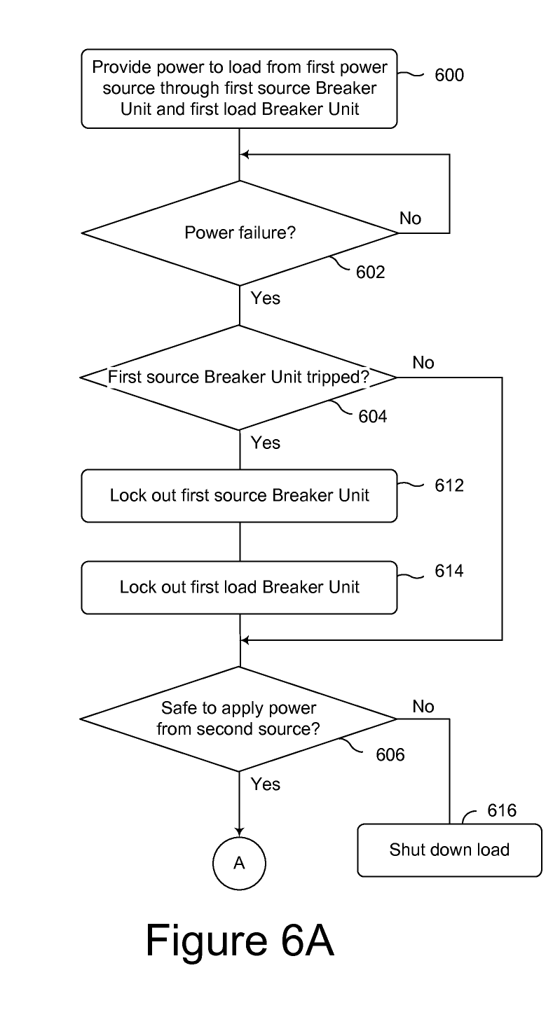

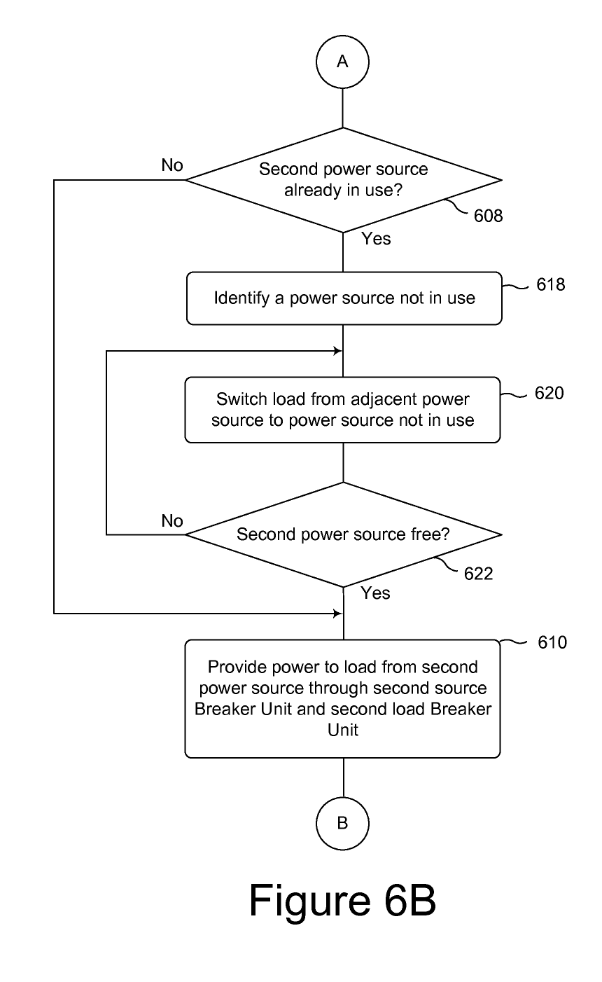

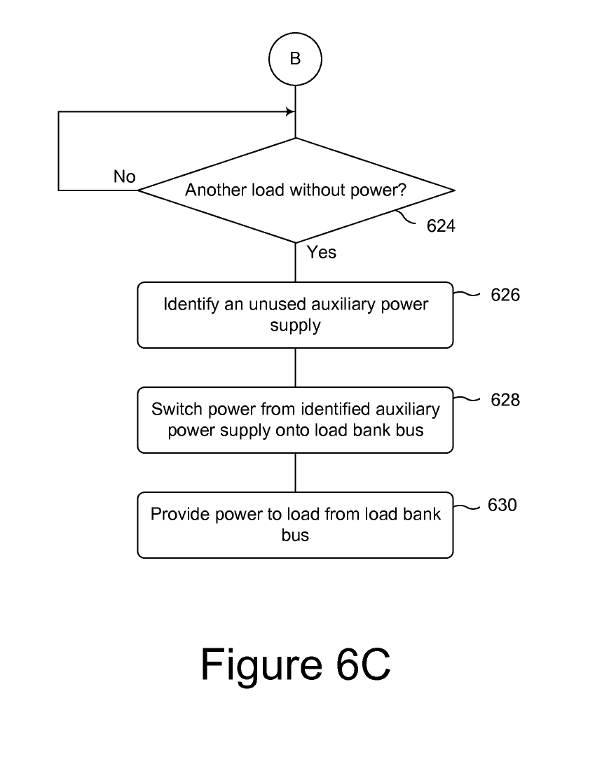

An example of a method of managing electrical power in a power distribution system having more power sources than loads, is shown in FIGS. 6A and 6B. The method begins with providing power to a load from a first power source through a first source breaker and a first load breaker (600). If (i) there is a power failure (602), (ii) the first source breaker has not been tripped (604), (iii) it is safe to apply power from a second source (606), and (iv) the second source is not already in use (608), power is provided to the load from the second source through a second source breaker and a second load breaker (610).

Returning to decision block 604, if the first source breaker has been tripped, the first source breaker is locked out (612) and the first load breaker is also locked out (614), for example to isolate the first source and any wiring between the first load breaker and the first source.

Returning to decision block 606, if it is not safe to apply power from a second source, for example if another load breaker trips when an attempt is made to apply power from the second source, the load is shut down (616).

Returning to decision block 608, if the second power source is already in use, another power source not in use is identified (618). A load drawing power from a power source adjacent the one not in use is switched to the one not in use (620). If this step frees up the previously-identified second power source (622), power is provided to the load from the second source through a second source breaker and a second load breaker (610). Returning to decision block 622, if this step does not free up the previously-identified second power source, the process is repeated until the second power source is free. This is an example of the application of Zipper Logic^{SM} functionality as already described previously.

Another example of a method of managing electrical power in a power distribution system having more than one subsystem and auxiliary power sources is shown in FIG. 6C. This is a continuation of the method illustrated in FIGS. 6A and 6B. If another load is without power (624): an unused auxiliary power source is identified (626); power is switched from the identified auxiliary power source onto a load bank bus (628); and power is provided to the load from the load bank bus (630). In some examples the identified auxiliary power source may be in a different subsystem than one or both of the loads not having power. This is an example of Fix-One Break-One^{SM} logic.

In the foregoing examples, as already discussed the controls may be implemented as PLCs. Such a PLC may be switchable between an automatic mode in which the PLC controls its breakers and a manual mode in which the breakers can be electrically operated through pushbuttons subject to interlocks as already described. The breakers themselves may also have manual controls that override interlocks except a continuous signal to a shunt trip. Each PLC can monitor more than one transfer breaker pair in one switchboard, thereby providing redundancy in case a PLC fails.

A master PLC may be provided for an entire system including multiple subsystems, for example to provide a user interface that shows the status of all breakers, provides on-line diagrams, transmits user commands to other PLCs, and the like. Digital signals may be transmitted by coaxial network cables, a digital out-digital in method, or other suitable data conductors.

In systems having a load bank bus, the bus may be used for such purposes as testing generators or other auxiliary power units one at a time, startup commissioning, periodic testing, and re-commissioning after repair, as well as the load transfer functions described above.

In some examples Schneider/Square-D type NW breakers were used for source isolation and type RJ or RK breakers were used for load isolation. The PLCs were provided by Schneider/Square-D/Modicon and in some instances used Intel Pentium 651-60 central processors. Software such as Concept software and Unity software may be used. These component selections are not critical, and similar components from other suppliers could also be used.

In one example each lockout relay is controlled directly by its associated source breaker. If the breaker trips, an auxiliary contact that closes when the breaker trips is actuated connecting control power to the lockout relay. The lockout relay is a two-state relay and is electrically operated by the breaker contact to transition from reset to tripped. To transition back requires manual operation of a handle on the relay, and this cannot be done if voltage is still being applied to the relay, which is the case if the breaker is still in the tripped condition. The downstream shunt trip associated with the load breaker is activated by a contact on the lockout relay that closes when the lockout relay is activated. The load breaker cannot be reset as long as power is being applied from the lockout relay to the shunt trip.

1. An electrical power system comprising:
a first source breaker and lockout relay;
a first power input in power-providing communication with the first source breaker;
a first load breaker having a shunt trip, the first source breaker and lockout relay in power-providing and trip-controlling communication with the first load breaker;
a second source breaker and lockout relay;
a second power input in power-providing communication with the second source breaker;
a second load breaker having a shunt trip, the second source breaker and lockout relay in power-providing and trip-controlling communication with the second load breaker; and
a controller in communication with the source breakers.

2. The electrical power system of claim 1 wherein the controller comprises two control units, one in communication with each of the source breakers.

3. The electrical power system of claim 1 and further comprising a power synchronizer in communication with the controller.

4. The electrical power system of claim 1, the controller to close the first source breaker and open the second source breaker if power is available at the first power input and if the first source breaker is not in a tripped state, and if power ceases to be available at the first power input or if the first source breaker trips, to close the second source breaker and open the first source breaker if power is available at the second power input and if the second source breaker is not in a tripped state.

5. The electrical power system of claim 4 and further comprising a power output in power-receiving communication with the load breakers.

6. The electrical power system of claim 5 and further comprising:
a plurality of pairs of source breakers and lockout relays, each pair including a first source breaker and lockout relay and a first power input and a second source breaker and lockout relay and a second power input;
a plurality of pairs of load breakers, each load breaker having a shunt trip, each pair of source breakers in power-providing and trip-controlling communication with one of the pairs of load breakers;
a plurality of power outputs each in power-receiving communication with one of the pairs of load breakers;
wherein, if power ceases to be available at any power input or if any source breaker trips, the controller is in communication with the source breakers to cause the source breakers sequentially to establish power-providing communication between the remaining power inputs and power outputs such that no power output is in power-receiving communication with more than one power input.

7. The electrical power system of claim 5 and further comprising:
a plurality of additional source breakers each including a lockout relay; and
a plurality of additional load breakers each having a shunt trip, each source breaker in power-providing and trip-controlling communication with one of the load breakers,
the source breakers and load breakers arranged in groups of four, first and third source breakers of each group having a common first power input, second and fourth source breakers of each group having a common second power input, first and second load breakers of each group having a common power output, and third and fourth load breakers of each group having a common power output,
wherein, if power ceases to be available at any power input or if any source breaker trips, the controller is in communication with the source breakers to cause the source breakers sequentially to establish power-providing communication between the remaining power inputs and power outputs such that no power output is in power-receiving communication with more than one power input.

8. The electrical power system of claim 1 and further comprising:
an auxiliary breaker in power-carrying communication with an auxiliary power input;
a load-bank breaker in power-carrying communication with a load bank input;
a tie breaker in power-receiving connection with the auxiliary and load-bank breakers and in power-providing communication with the first source breaker; and
a utility breaker in series connection between the first power input and the first source breaker.

9. The electrical power system of claim 8 and further comprising a load bank bus in communication with the load bank input and a generator in communication with the auxiliary power input.

10. The electrical power system of claim 9, the controller to close the utility breaker if power is available at the first power input, and if not, to start the generator and close the auxiliary and tie breakers, and if power is not available from the generator to close the load-bank and tie breakers if power is available from the load bank bus.

11. The system of claim 10, the controller to establish a power connection through the load bank bus between any generator not in use and any load not having power.

12. A method of managing electrical power in a power distribution system having more power sources than loads, the method comprising:
applying power from a first power source through a first source protector to a load through a first load protector;
upon failure of the first power source to provide power or upon trip of the first source protector, applying power from a second power source through a second source protector to the load through a second load protector; and
upon trip of the first source protector, locking the first source protector and the first load protector in an open-circuit state.

13. The method of claim 12 and further comprising shutting down the load if the second source protector is tripped.

14. The method of claim 12 and further comprising, if the second power source is already providing power to another load, redistributing loads by sequentially switching each load from one power source to another such that all loads are being provided with power and no power source is providing power to more than one load.

15. The method of claim 14 wherein:
each power source comprises primary and auxiliary power supplies, and
failure of a power source to provide power comprises failure to provide power from its primary and auxiliary power supplies.

16. The method of claim 15 and further comprising, upon failure of a second load to receive power from its associated power sources, identifying an unused auxiliary power supply and applying power from the identified auxiliary power supply to the second load.

17. The method of claim 16 wherein applying power from the identified auxiliary power supply comprises connecting the identified auxiliary power supply and the second load to a load bank bus.

18. An electrical power system comprising:
first and second load breakers each having a shunt trip and a power output connection;
a first source breaker including a lockout relay, the first source breaker having a power input connection;
a second source breaker including a lockout relay, the second source breaker having a power input connection;
the first source breaker in power-providing connection with the first load breaker and the first load breaker lockout relay in controlling communication with the first load breaker shunt trip;
the second source breaker in power-providing connection with the second load breaker and the second load breaker lockout relay in controlling communication with the second load breaker shunt trip;
a controller; and
a data link between the controller and the source breakers.

19. The system of claim 18 wherein the controller comprises first and second control units and the data link comprises three communication channels, one channel between the first control unit and the first source breaker, a second channel between the second control unit and the second source breaker, and a third channel between the two control units.

20. The system of claim 18 and further comprising a synchronizer and a data link between the synchronizer and the controller.

21. The system of claim 18 and further comprising:
an auxiliary breaker having an auxiliary power input connection;
a load-bank breaker having a load bank power connection;
a tie breaker in power-receiving connection with the auxiliary and load-bank breakers and in power-providing connection with the first source breaker;
a utility breaker in series between the first power input connection and the first source breaker; and wherein:
the data link extends between the controller and the auxiliary, load-bank, tie, and utility breakers.

22. The system of claim 21 and further comprising an additional source breaker in power-receiving connection with the utility and tie breakers.
